(19) United States
(12) Patent Application Publication
(10) Pub. No.: US 2009/0045349 A1
(43) Pub. Date: Feb. 19, 2009

(54) Sample enclosure for inspection and methods of use thereof

(76) Inventors: David Sprinzak, Pasadena, CA (US); Yiftah Karni, Rehovot (IL); Yitzhak Ronen, Ephraim (IL)

Correspondence Address: Pearl Cohen Zedek Latzer, LLP, 1500 Broadway, 12th Floor, New York, NY, 10036, US

(21) Appl. No.: 11/660,929

(22) PCT Filed: Aug. 25, 2005
(86) PCT No.: PCT/IL05/00919

§ 371 Date: Feb. 23, 2007

Related U.S. Application Data
(60) Provisional application No. 60/640,247, filed on Jan. 3, 2005.
(60) Provisional application No. 60/604,376, filed on Aug. 26, 2004.

(51) Int. Cl. G01N 21/51; G01K 5/10

(52) U.S. Cl. 250/432 R; 250/441.11

(57) ABSTRACT

A sample container assembly for use in a microscope including a sample enclosure, an electron beam permeable, fluid impermeable, membrane sealing the sample enclosure from a volume outside the sample enclosure and a pressure controller assembly communicating between the sample enclosure and a volume outside the sample enclosure.

### FIELD OF THE INVENTION

The present invention relates to inspection of samples generally and more particularly to sample containers and inspection systems for use in, for example, scanning electron microscopes, as well as methods for utilization thereof.

### BACKGROUND OF THE INVENTION

The use of a sample container may allow for imaging of a sample in a microscope, such as a scanning electron microscope (SEM). During imaging of the sample a membrane of the sample container may bow out or be generally displaced due to a difference in pressure within the sample container and the evacuated environment of the microscope.

### SUMMARY

Embodiments of the present invention may provide apparatus, systems and methodologies for enabling inspection of samples.

There is thus provided in accordance with an embodiment of the present invention a sample container assembly for use in a microscope including a sample enclosure, an electron beam permeable, fluid impermeable, membrane sealing the sample enclosure from a volume outside the sample enclosure and a pressure controller assembly communicating between the sample enclosure and a volume outside the sample enclosure. Additionally, the pressure controller assembly may prevent longitudinal displacement of the membrane beyond a selected longitudinal distance. Preferably, the pressure controller assembly may maintain a volume of the sample enclosure at a pressure, whereby a pressure differential across the membrane does not exceed a threshold level at which excessive bowing out of the membrane would occur.

In accordance with an embodiment of the present invention the pressure controller assembly includes a flexible tube element. Additionally, the pressure controller assembly includes a fluid passageway communicating with the flexible tube element. Alternatively, the pressure controller assembly includes a piston assembly.

In accordance with an embodiment of the present invention the sample container assembly for use in a microscope may include a sample support assembly. Additionally, the sample container support assembly may be configured to seat the sample container therein. Preferably, the sample container support assembly may be configured to be placed in the microscope.

There is thus provided in accordance with an embodiment of the present invention a sample inspection system including, a sample container assembly for use in a microscope and a microscope. Preferably, the sample inspection system may include at least one of, an X-ray detector arranged to receive X-rays from a sample in the sample enclosure, a light detector arranged to receive light in the ultraviolet to infrared range from a sample in the sample enclosure, a backscattered electron detector arranged to receive backscattered electrons from a sample in the sample enclosure and a secondary electron detector arranged to receive secondary electrons from a sample in the sample enclosure.

There is thus provided in accordance with an embodiment of the present invention a sample container support assembly including a pressure controller assembly including a piston assembly, an aperture for placing a sample container in the sample container support assembly, and a fluid passageway connecting the aperture with the pressure controller assembly. Additionally, sample container support assembly may be configured to be placed in the microscope. Preferably, the sample container support assembly includes a sealant for sealing the fluid passageway from a volume outside of the sample support assembly.

In accordance with an embodiment of the present invention the sample container support assembly includes an electrically conductive element. Additionally, the piston assembly may be to enlarge a volume surrounding a sample in the sample container, thereby reducing a pressure within the sample container. Preferably, the sample container includes a sample enclosure, and an electron beam permeable, fluid impermeable, membrane sealing the sample enclosure from a volume outside the sample enclosure.

There is thus provided in accordance with an embodiment of the present invention a method of microscopy including allowing fluid to flow out of a sample container with a sample therein, the sample container placed in an evacuated environment of a microscope, the sample container sealed by an electron beam permeable, fluid impermeable, membrane, and imaging results of interactions of a beam of electrons with the sample in the sample container. Additionally, allowing fluid to flow out of a sample container may be for preventing longitudinal displacement of the membrane beyond a selected longitudinal distance. Preferably, allowing fluid to flow out of a sample container may be for maintaining a volume of the sample enclosure at a pressure, whereby a pressure differential across the membrane does not exceed a threshold level at which excessive bowing out of the membrane would occur.

In accordance with an embodiment of the present invention allowing fluid to flow out of a sample container includes releasing fluid from the sample enclosure via a flexible tube element. Additionally, releasing fluid includes flowing of the fluid from the sample enclosure through a fluid passageway to the flexible tube element. Alternatively, allowing fluid to flow out of a sample container includes moving a piston assembly. Preferably, longitudinal movement of a piston of the piston assembly enlarges a volume surrounding the sample in the sample container, thereby reducing a pressure within the sample container.

In accordance with an embodiment of the present invention allowing fluid to flow out of a sample container includes providing a sample support assembly. Preferably, the method of microscopy includes seating the sample container in the sample support assembly. Additionally, the method of microscopy includes seating the sample container support assembly in a microscope. Preferably, allowing fluid to flow out of a sample container includes providing a sample support assembly so as to receive the fluid flowing out of the sample container.

There is thus provided in accordance with an embodiment of the present invention a sample container assembly for use in a microscope including a sample enclosure, an electron beam permeable, fluid impermeable, membrane sealing the sample enclosure from a volume outside the sample enclosure, a positioner, the positioner including an accordion type element for positioning a sample generally in proximity to the membrane. Preferably, the sample container assembly includes a pressure controller assembly communicating between the sample enclosure and a volume outside the sample enclosure. Additionally, the pressure controller assembly includes a flexible tube element.

### BRIEF DESCRIPTION OF THE DRAWINGS

The present invention will be understood and appreciated more fully from the following detailed description, taken in conjunction with the drawings in which:

FIGS. 1A and 1B are oppositely facing simplified exploded view pictorial illustrations of a disassembled sample container constructed and operative in accordance with an embodiment of the present invention;

FIGS. 2A and 2B are oppositely facing simplified pictorial illustrations of a sample container in a fully assembled state, in accordance with an embodiment of the present invention;

FIGS. 3A and 3B are oppositely facing simplified partially pictorial, partially sectional illustrations taken along lines IIIA-IIIA and IIIB-IIIB, respectively, in FIGS. 2A and 2B in a partially assembled state, in accordance with an embodiment of the present invention;

FIGS. 4A, 4B and 4C are three sectional illustrations showing the operative orientation of a sample container at three stages of operation, in accordance with an embodiment of the present invention;

FIG. 5 is a simplified pictorial and sectional illustration of a microscope inspection of a sample using a sample container of an embodiment of the present invention.

FIGS. 6A and 6B are oppositely facing simplified exploded view pictorial illustrations of a disassembled sample container constructed and operative in accordance with an embodiment of the present invention;

FIGS. 7A and 7B are oppositely facing simplified pictorial illustrations of a sample container, in accordance with an embodiment of the present invention;

FIGS. 8A and 8B are oppositely facing simplified partially pictorial, partially sectional illustrations taken along lines VIIIA-VIIIA and VIIIB-VIIIB, respectively, in FIGS. 7A and 7B in a partially assembled state, in accordance with an embodiment of the present invention;

FIGS. 9A, 9B and 9C are three sectional illustrations showing the operative orientation of a sample container at three stages of operation, in accordance with an embodiment of the present invention;

FIG. 10 is a simplified pictorial and sectional illustration of a microscope inspection of a sample using a sample container, in accordance with an embodiment of the present invention;

FIGS. 11A and 11B are respective simplified top and bottom view pictorial illustrations of a sample container support assembly constructed and operative in accordance with an embodiment of the present invention;

FIG. 12 is a simplified sectional illustration of a sample container support assembly taken along lines XII-XII in FIG. 11A, in accordance with an embodiment of the present invention;

FIG. 13 is a simplified exploded view illustration of a sample container support assembly, in accordance with an embodiment of the present invention;

FIGS. 14A and 14B are a simplified pictorial illustration and a simplified sectional illustration taken along lines XIVB-XIVB in FIG. 14A together showing the operative orientation of a sample container support assembly with a sample container at an initial stage of operation constructed and operative in accordance with an embodiment of the present invention;

FIGS. 15A and 15B are a simplified pictorial illustration and a simplified sectional illustration taken along lines XVB-XVB in FIG. 15A together showing the operative orientation of a sample container support assembly with a sample container at an intermediate stage of operation constructed and operative in accordance with an embodiment of the present invention; and

FIGS. 16A and 16B are a simplified pictorial illustration and a simplified sectional illustration taken along lines XVIB-XVIB in FIG. 16A together showing the operative orientation of a sample container support assembly with a sample container at an advanced stage of operation constructed and operative in accordance with an embodiment of the present invention.

### DETAILED DESCRIPTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

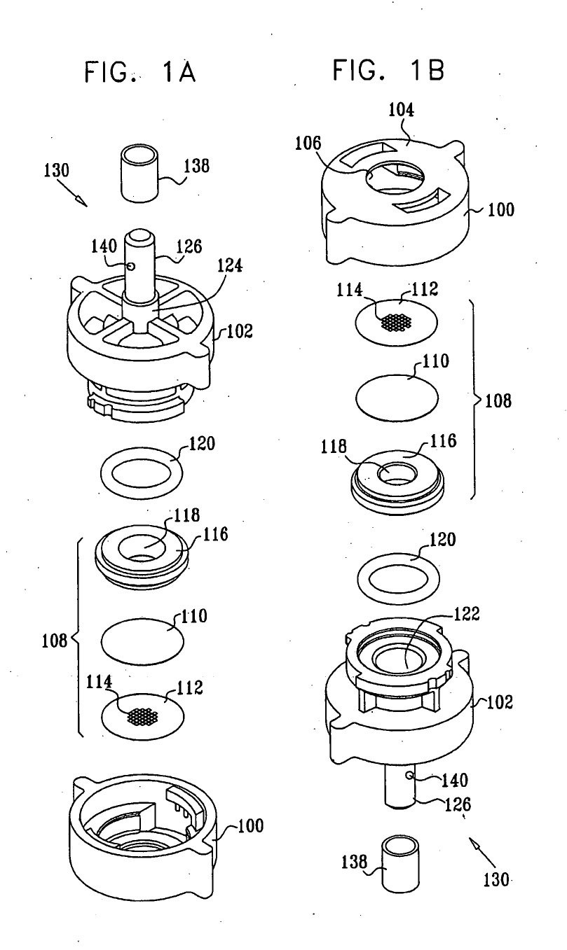

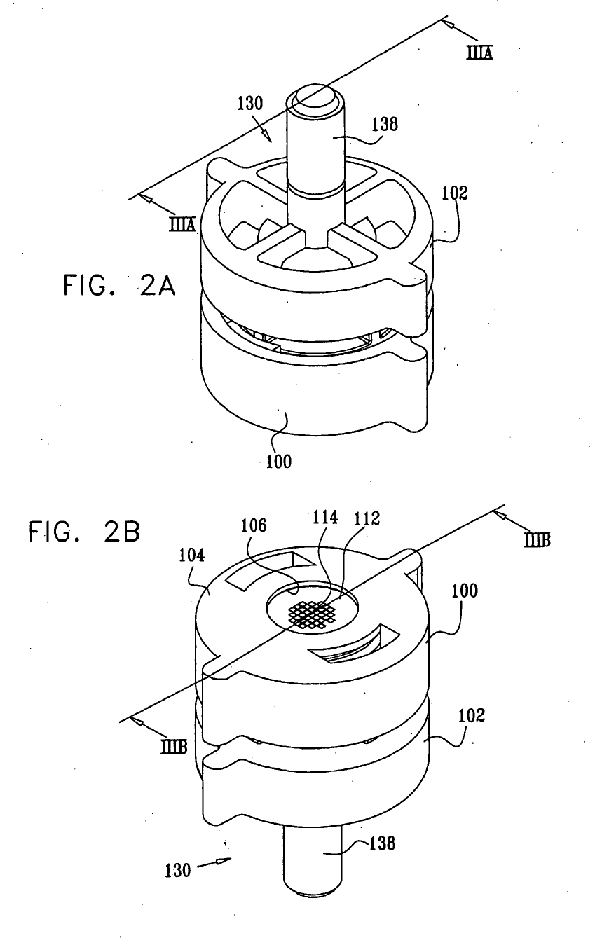

Reference is now made to FIGS. 1A-3B, which are oppositely facing simplified pictorial illustrations of a sample container assembly including a sample container, such as a scanning electron microscope (SEM) compatible sample container, such as, for example, that disclosed in embodiments described in PCT patent application WO/2004/075209, which is hereby incorporated by reference herein in its entirety; PCT patent application WO03/104848, which is hereby incorporated by reference herein in its entirety and PCT patent application WO03/104846, which is hereby incorporated by reference herein in its entirety. Other sample containers may be used with embodiments of the present invention. As seen in FIGS. 1A and 1B, the sample container may include first and second mutually engaged enclosure elements, respectively designated by reference numerals 100 and 102.

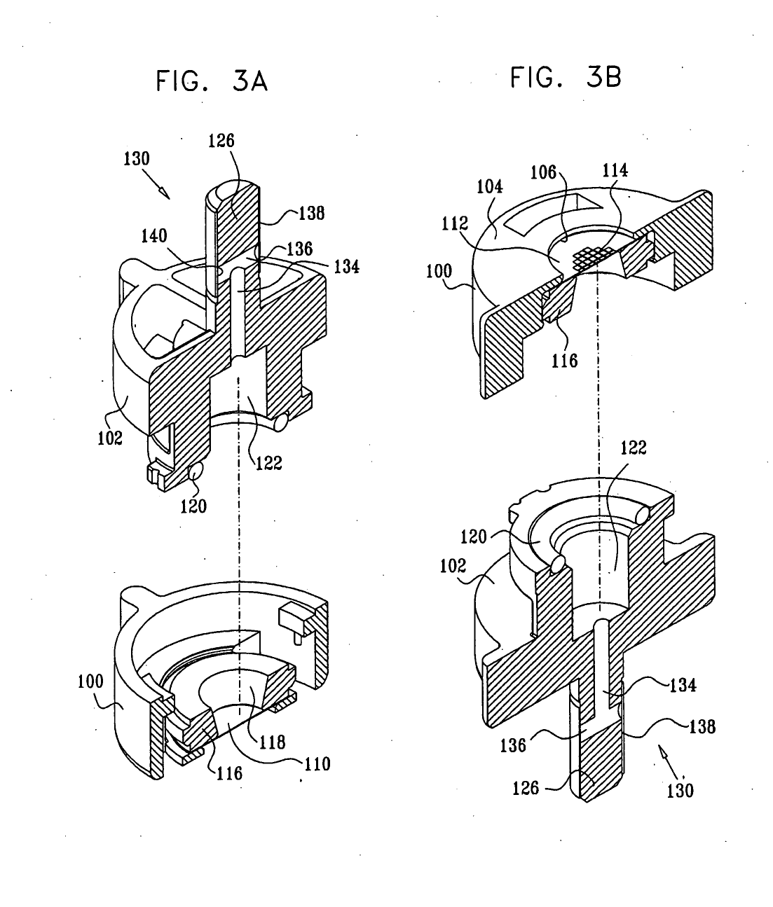

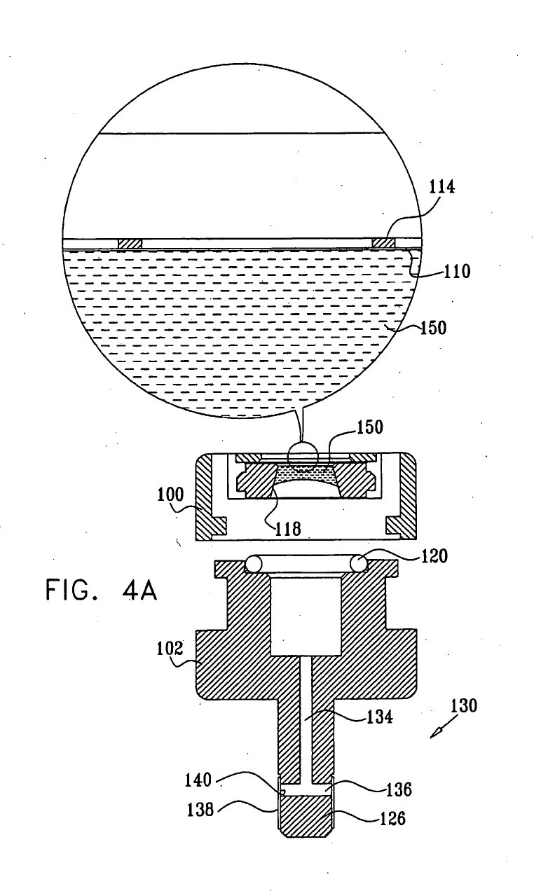

First enclosure element 100 may have a base surface 104 having a generally central opening, or aperture 106, for example. Alternatively, aperture 106 need not be centrally located. A cover or membrane assembly, such as, for example, an electron beam permeable, fluid impermeable, membrane subassembly 108, may be seated inside enclosure element 100 against and over aperture 106, as shown in FIGS. 3A and 3B. Aperture 106 may be configured in any other suitable configuration. Furthermore, a multiplicity of apertures may be defined within the sample container. It is noted that other covers or membranes may be used.

Turning to membrane subassembly 108, it is seen that an electron beam permeable, fluid impermeable, membrane 110 may be attached in any suitable manner, such as by an adhesive, for example, to a grid support element 112, which may define at its center a mechanically supporting grid 114. Other suitable attaching methods may be used. It is appreciated that alternative suitable mechanisms may be employed for mechanically supporting the membrane 110.

A sample enclosure, such as a sample placement volume defining ring 116, defining an aperture therein, may be connected or adhered to membrane 110, in any suitable manner, such as, by an adhesive, for example, thus sealing the sample enclosure from a volume outside the sample enclosure. Ring 116 may be configured to define a sample placement volume 118 having, for example, inclined walls.

As seen in FIGS. 1A, 1B, 3A and 3B, an O-ring 120 may be disposed between ring 116 and an interior surface 122 of second enclosure element 102. O-ring 120 may be operative, when enclosure elements 100 and 102 are in tight engagement, to obviate the need for the engagement of elements 100 and 102 to be a sealed engagement. It is appreciated that any suitable sealing mechanism may be used in place of O-ring 120, such as a diaphragm (not shown). In an alternative embodiment O-ring 120 need not be used and an alternative arrangement of enclosure elements 100 and 102, with or without O-ring 120 or other sealing mechanism, may be used.

Second enclosure element 102 may be formed with a generally central stub 124 including a distal portion 126. Central stub 124 may be arranged to be seated, for example, in a suitable recess (not shown) in a sample stage of a microscope. It is a particular feature of one embodiment of the present invention that the sample container, shown in FIGS. 1A-5, is sized and operative with conventional stub recesses in conventional microscopes and does not require any modification. It is appreciated that various configurations and sizes of stubs may be provided so as to fit various microscopes or any other suitable sample inspection system.

In one embodiment of the present invention a sample container is provided with pressure controller functionality, such as a valve assembly or relief assembly or pressure controller assembly 130 communicating between the sample enclosure, such as ring 116, for example, and a volume outside the sample enclosure. The valve assembly or relief assembly or pressure controller assembly 130 may be operative to maintain the sample placement volume 118, during microscopic inspection, at a pressure whereby a pressure differential across the membrane 110 does not exceed a threshold level at which excessive displacement or bowing out of the membrane 110 would occur. Excessive bowing out of the membrane 110 may prevent a sample placed in sample placement volume 118 from lying up and against the membrane 110 thus impairing imaging of a sample in the sample container in a SEM or any other suitable inspection system. Typically, the threshold level is a pressure differential wherein longitudinal displacement of the membrane 110, due to bowing out, is a longitudinal distance in the range of approximately 10-1000 nm, for example.

Furthermore, the pressure controller assembly 130 may prevent longitudinal displacement of the membrane 110 beyond a selected longitudinal distance, which may be an effective, operable or operative longitudinal distance, wherein imaging of a sample in the sample container in a microscope is impaired, as will be further described hereinbelow.

The valve assembly or relief assembly or pressure controller assembly may have constructions and operations other than shown herein, and more than one assembly or valve or relief element may be used.

It is appreciated that the threshold level may vary in accordance with other parameters, such as the membrane thickness; properties of the sample, such as the depth that imaged sample features are located within the sample; properties of an impinging electron beam, such as the focusing sharpness of an impinging electron beam. For example, in a situation wherein imaging of features of a sample may be achievable for an electron beam focusing sharpness maintained by allowing the electron beam to travel a distance no greater than approximately 300 nm from an electron beam source of the microscope to the sample; a membrane thickness of approximately 100 nm and wherein the imaged sample features are located at a depth of approximately 50 nm within the interior of the sample, the longitudinal displacement of a membrane should preferably not exceed 150 nm. Other thicknesses and distances may be used.

As seen in FIGS. 3A and 3B, pressure controller assembly 130 may include a central tube, channel or bore 134 formed in second enclosure element 102. Central bore 134 may extend from interior surface 122 to, for example, a perpendicular throughgoing channel or bore 136, which may be formed in portion 126 of central stub 124 and communicates therewith. A pressure release device, such as a flexible tube element 138 may sealingly engage orifices 140 defined by throughgoing bore 136. Tube element 138 may be formed of any suitable material, typically a flexible material, such as latex or silicon. One example is a silicon tube which may be commercially available from Goldmold Technology of 4 Kabirim St., Haifa, Israel. Bore 136 need not be perpendicular, and need not have multiple openings.

It is appreciated that the pressure controller assembly may be structured in various configurations. In one example of an alternative embodiment, a single diaphragm or a multiplicity of diaphragms (not shown) may be used in place of a flexible tube element. Additionally, the pressure controller assembly may be placed in any suitable portion of the sample container, such as forming a pressure release channel, in the first enclosure element 100, for example, and providing a suitable pressure control valve.

As can be seen in some embodiments of present invention a sample container may be operative to contain a fluid-containing sample and the sample may be imaged in an inspection system, such as a microscope, for example. Pressure within the sample container may be a fluid pressure which may be higher than an evacuated pressure in the evacuated microscope environment. A resulting pressure differential across the membrane of the sample container may cause the membrane to be displaced or bow out. Bowing out or displacement of the membrane may form a gap between the membrane and the fluid-containing sample. Thus imaging of the sample may be impaired, such as impairment due to loss of information from the sample. An example for loss of information may be loss of information due to a decrease in the imaging resolution. Decrease in the imaging resolution may be caused by a decrease in the sharpness of focusing of an electron beam generated by the microscope. Decrease in the focusing sharpness may be due to the gap, which may cause the electron beam to travel along a longer distance to the sample.

A valve assembly or relief assembly or pressure controller assembly including a pressure release device, such as a valve or flexible tube element may provide pressure relief by allowing fluid to be released from the sample container, thus the pressure differential across the membrane may be decreased causing the gap between the sample and the membrane to lessen.

Thus, typically after a sample container with a fluid-containing sample is placed in a microscope the microscope is evacuated. During evacuation of the microscope, typically within a time range of a few minutes, for example, or while the sample container is in an evacuated environment of the microscope pressure builds up in the sample container and a pressure differential across the membrane, such as 1 atmosphere, for example, may cause a gap of approximately 500 nm, for example. The pressure buildup in the sample container may force the flexible tube element to bow out and form an opening for fluid egress so as to allow fluid to be released from the sample container. Release of fluid from the sample container may cause a decrease in the pressure build up in the sample container and the pressure differential to decrease, such as to approximately 150 millibars, for example, and the gap to lessen, such as to 150 mm, for example. Once the pressure buildup within the sample container decreases the flexible tube element may relax and substantially resume to its position prior to bowing out. Other pressure differentials across the membrane and other degrees in the decrease of pressure within the sample container may occur in embodiments of the present invention.

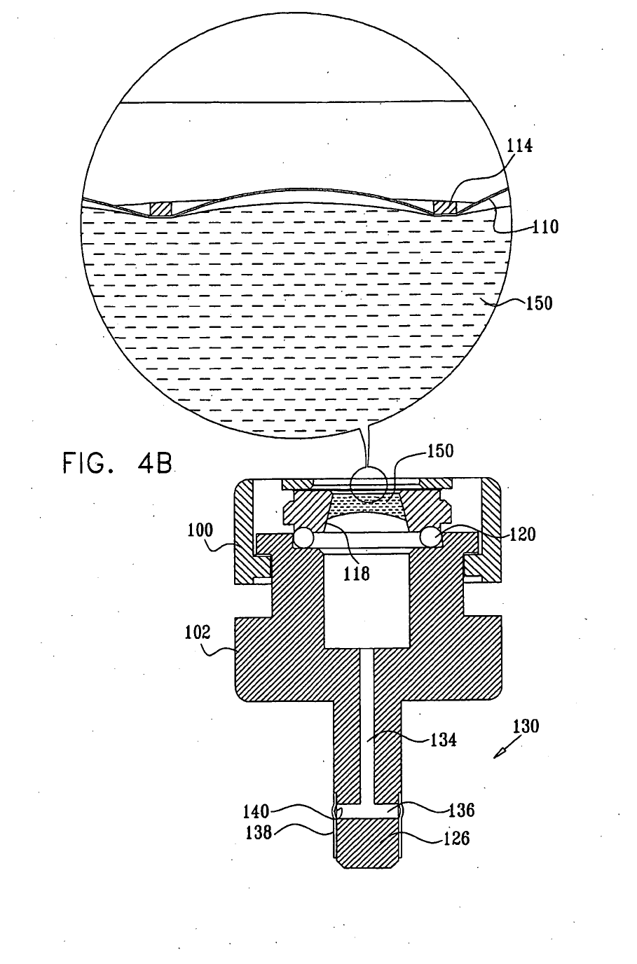

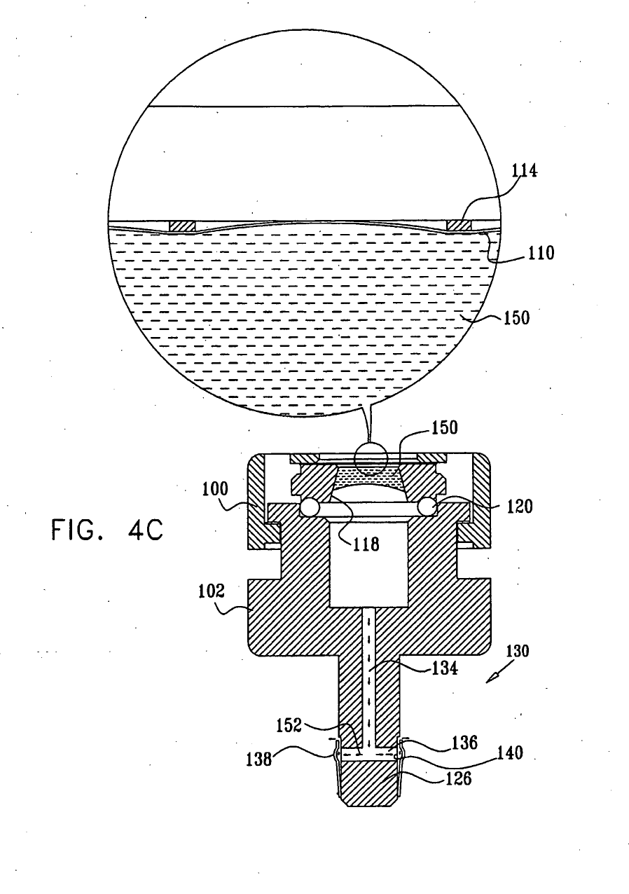

Reference is now made to FIGS. 4A, 4B and 4C, which are three sectional illustrations showing the operative orientation of an embodiment of the sample container at three stages of operation. FIG. 4A shows the sample container containing a fluid-containing sample, such as a liquid sample 150, for example, and arranged in the orientation shown in FIG. 1B, prior to closure of enclosure elements 100 and 102. Membrane 110 is seen in FIG. 4A to be generally planar and tube element 138 is seen to be sealingly engaging orifices 140.

FIG. 4B shows an embodiment of the container of FIG. 4A following full engagement between enclosure elements 100 and 102 and placement into a SEM or any other suitable sample inspection system. The environment of the SEM following evacuation may be, typically, a vacuum of 10⁻²-10⁻⁶ millibars. It is seen that grid 114 and membrane 110 are generally displaced or bow outwardly and further that the membrane 110 tends to be forced into and through the interstices of grid 114 due to pressure buildup in the sample placement volume 118, and due to the pressure differential between the pressure within the sample container and the evacuated pressure in the SEM or any other suitable sample inspection system. Tube element 138 may be displaced or bow out slightly due to pressure buildup in the sample placement volume 118.

FIG. 4C shows the container of FIG. 4B some time following placement into an evacuated environment of a SEM or any other suitable sample inspection system. Fluid, typically air, for example, enclosed in sample placement volume 118 may flow outwardly via central bore 134 to perpendicular throughgoing bore 136. Other fluids may be used. Central bore 134 and perpendicular throughgoing bore 136 may define a fluid passageway communicating with the tube element 138. Tube element 138 may subsequently bow outwardly and allow the fluid to be released into the ambient, as diagrammatically illustrated by arrows 152. It is seen that the membrane 110 is displaced or bows slightly outwardly due to pressure buildup in the sample placement volume 118 however to a significantly lesser extent, due to the action of the valve assembly or pressure controller assembly 130. This can be seen by comparing FIG. 4C with FIG. 4B. Supporting grid 114 is seen to be generally planar.

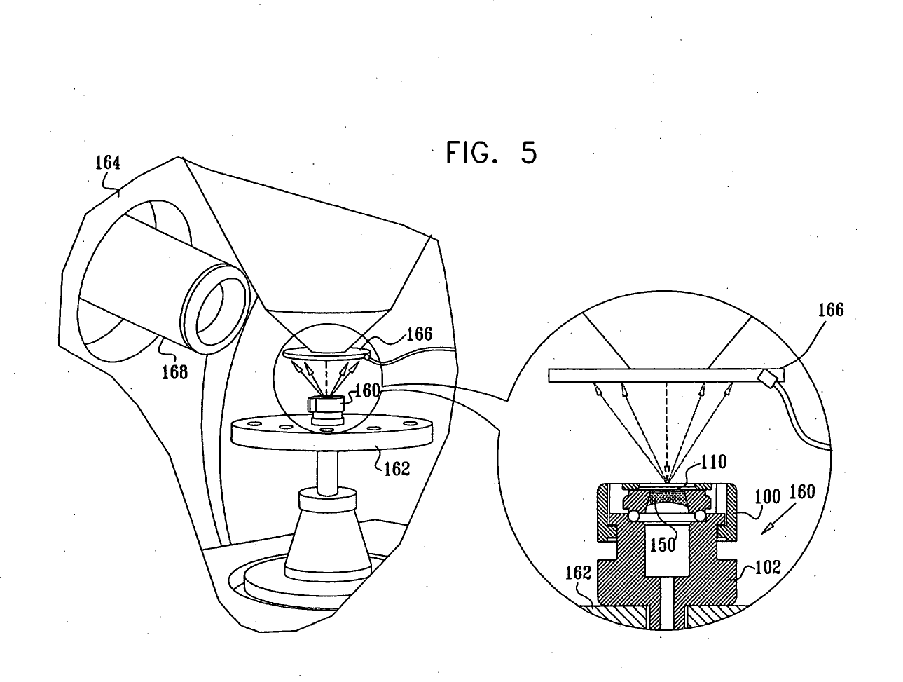

Reference is now made to FIG. 5, which is a simplified pictorial and sectional illustration of an embodiment of an inspection of sample 150 in a sample inspection system, such as a SEM, using the sample container. As seen in FIG. 5, the sample container, here designated by reference numeral 160, is shown positioned on a stage 162 of a SEM 164 wherein imaging by a beam of electrons may be performed for analysis of results of interactions of the beam of electrons with the sample 150.

Backscattered electrons from sample 150 may pass through electron beam permeable, fluid impermeable, membrane 110 and may be detected by a detector 166, forming part of the SEM 164. One or more additional detectors, such as a secondary electron detector 168, may also be provided. An X-ray detector (not shown) may be provided for detecting X-ray radiation emitted by the sample 150 due to electron beam excitation thereof and a light detector, such as a cathodoluminescent detector (not shown) may also be provided for detecting radiation emitted by the sample 150 due to electron beam excitation thereof. Furthermore, any other suitable detector may be employed.

It is appreciated that in an alternative embodiment a light guide (not shown) may be inserted within the sample container, within central bore 134 of stub 124, for example, and attached thereto by any suitable method, such as by an adhesive, for example. The light guide may be employed to collect light emitted from a sample in the sample container. An example of such a sample container with a light guide is disclosed in PCT patent application WO03/104848, which is hereby incorporated by reference herein in its entirety and PCT patent application WO03/104846, which is hereby incorporated by reference herein in its entirety.

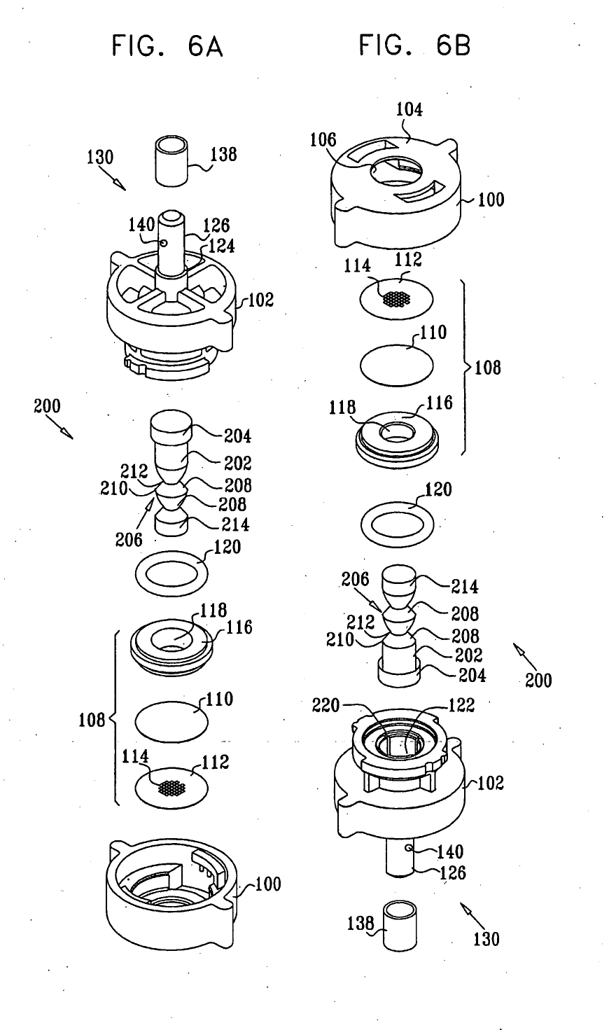

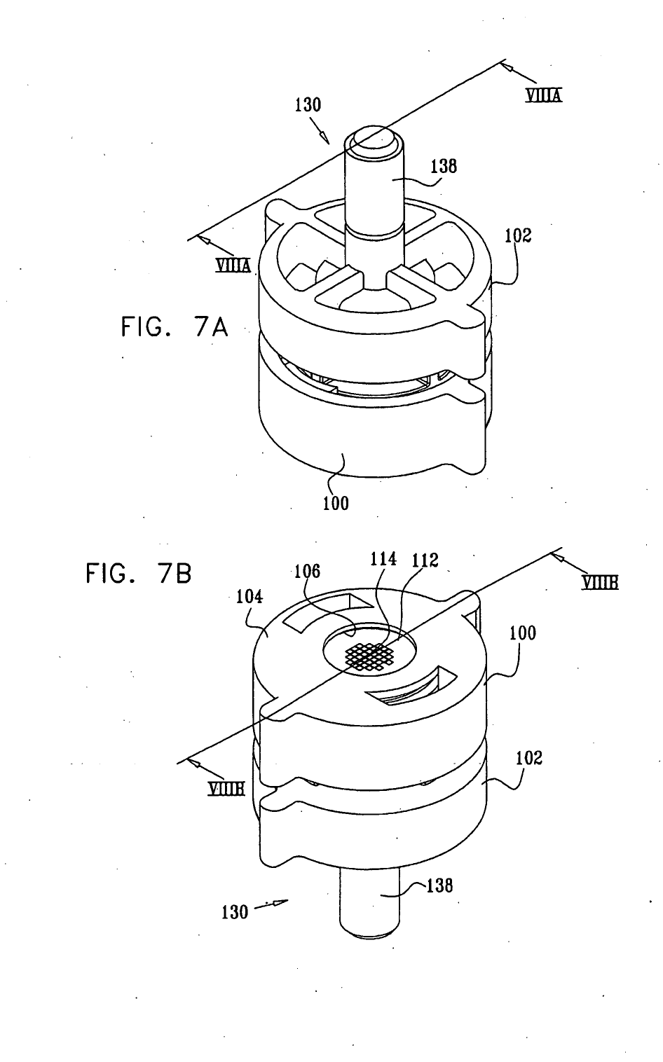

Reference is now made to FIGS. 6A-8B, which are oppositely facing simplified pictorial illustrations of an alternative embodiment of a sample enclosure assembly or a sample container, such as a SEM compatible sample container, which may be structured and operative to be used for substantially non-liquid samples, such as solid-containing samples, such as biological tissue; ceramic materials; paper; fabrics; toxic materials, such as asbestos, for example; biofilms; pastes, such as cements; and powders, for example. Other materials may be imaged. As seen in FIGS. 6A and 6B, the sample container may include some elements corresponding to those described in reference to FIGS. 1A-5.

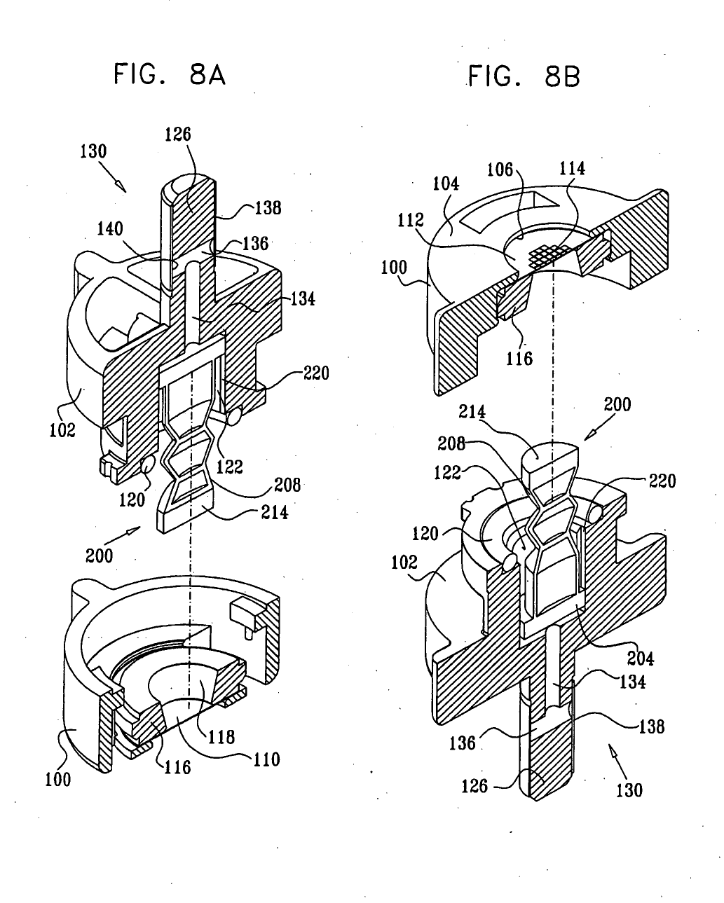

An accordion-type sleeve element or a flexible positioning element 200 may be seated within interior surface 122 of second enclosure element 102. Flexible positioning element 200 may include a generally elongated cylindrical portion 202 extending from a generally cylindrical base portion 204. An intermediate portion 206 extending from cylindrical portion 202 may include, for example, an accordion-type or other flexible sleeve configuration, which may include, for example, a plurality of truncated tapered portions 208 each defining a base section 210 and top section 212. As seen in FIGS. 6A, 6B, 8A and 8B, a pair of tapered portions 208 may be alternately coupled at top sections 212 of each of the tapered portions 208 and bottom sections 210 of each of the tapered portions 208, thus forming an accordion-type configuration. A top portion 214 may extend from intermediate portion 206.

Flexible positioning element 200 may be formed of any suitable material, such as an elastomeric material, for example, such as silicon or nitrile, for example.

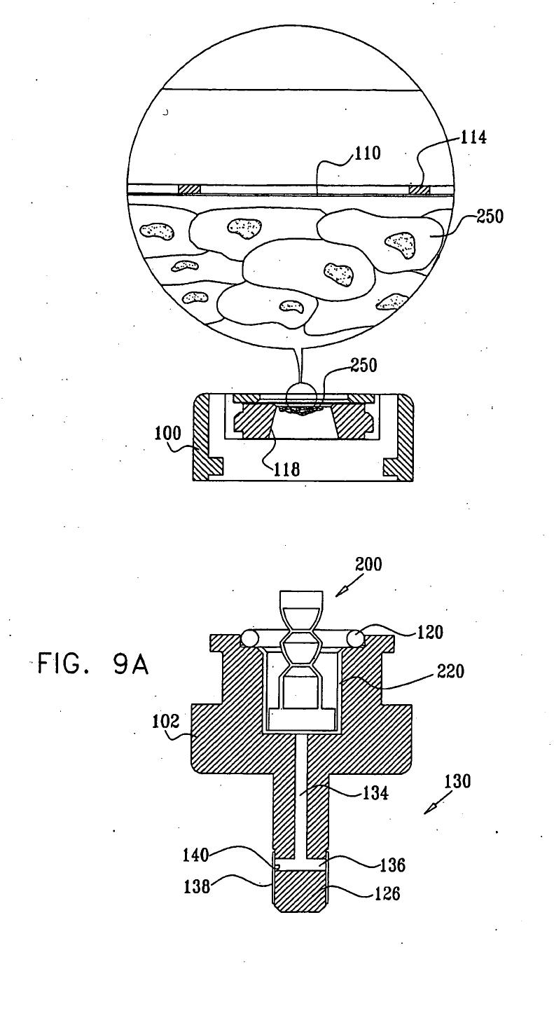

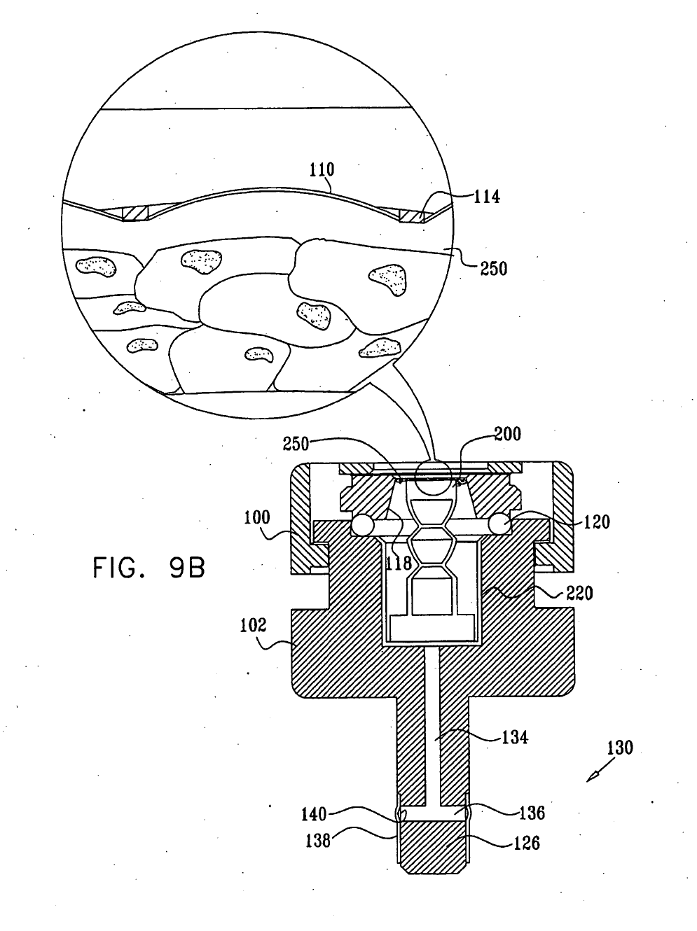

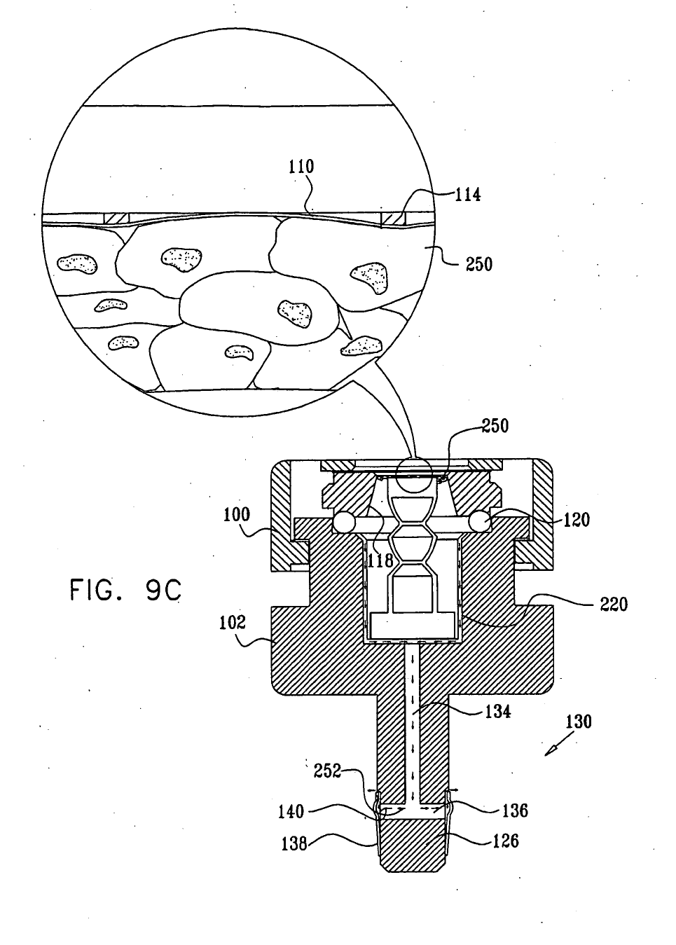

Flexible positioning element 200 may move or press a substantially solid-containing sample up and against membrane 110 when enclosure elements 100 and 102 are in tight engagement, as seen in FIGS. 9B and 9C hereinbelow.

It is appreciated that any suitable element for moving or holding a substantially solid-containing sample in proximity to the membrane 110 may be used, such as a spring element or plunger assembly.

Interior surface 122 may define therein a single recess or a plurality of recesses 220, which may communicate with central bore 134. Recesses 220 may be provided for fluid egress from the sample placement volume 118 upon full tight engagement of enclosure elements 100 and 102, as will be further described in reference to FIGS. 9A-9C. Alternatively, recesses 220 may be defined in any other suitable location within the sample container.

Reference is now made to FIGS. 9A, 9B and 9C, which are three sectional illustrations showing the operative orientation of an embodiment of the sample container at three stages of operation. FIG. 9A shows the sample container containing a substantially solid-containing sample, such as a tissue sample 250 and arranged in the orientation shown in FIG. 6B, prior to closure of enclosure elements 100 and 102. Membrane 110 is seen in FIG. 9A to be generally planar and tube element 138 is seen to be sealingly engaging orifices 140.

FIG. 9B shows an embodiment of the container of FIG. 9A following full engagement between enclosure elements 100 and 102 and following placement into a SEM or any other suitable sample inspection system. The environment of the SEM following evacuation may be, typically, a vacuum of 10⁻²-10⁻⁶ millibars. It is seen that grid 114 and membrane 110 are generally displaced or bow outwardly and further that the membrane 110 tends to be forced into and through the interstices of grid 114 due to pressure buildup in the sample placement volume 118, and due to the pressure differential between the pressure within the sample container and the evacuated pressure in the SEM or any other suitable sample inspection system. Tube element 138 may be displaced or bow out slightly due to pressure buildup in the sample placement volume 118.

FIG. 9C shows the container of FIG. 9B some time following placement into an evacuated environment of a SEM or any other suitable sample inspection system. Fluid, typically air, enclosed in sample placement volume 118 may flow outwardly via recesses 220 and central bore 134 to perpendicular throughgoing bore 136. Tube element 138 may subsequently bow outwardly and allow the fluid to be released into the ambient, as diagrammatically illustrated by arrows 252. It is seen that the membrane 110 is displaced or bows slightly outwardly due to pressure buildup in the sample placement volume 118 however to a significantly lesser extent, due to the action of the valve assembly or pressure controller assembly 130. This can be seen by comparing FIG. 9C with FIG. 9B. Supporting grid 114 is seen to be generally planar.

Reference is now made to FIG. 10, which is a simplified pictorial and sectional illustration of an embodiment of a sample inspection of sample 250 in an inspection system, such as a SEM, using the sample container. As seen in FIG. 10, the sample container, here designated by reference numeral 260, is shown positioned on stage 162 of SEM 164 wherein imaging by a beam of electrons may be performed for analysis of results of interactions of the beam of electrons with the sample 250. Backscattered electrons from sample 250 may pass through electron beam permeable, fluid impermeable, membrane 110 and may be detected by detector 166, forming part of the SEM 164. One or more additional detectors, such as secondary electron detector 168, may also be provided. An X-ray detector (not shown) may be provided for detecting X-ray radiation emitted by the sample 250 due to electron beam excitation thereof and a light detector, such as a cathodoluminescent detector (not shown) may also be provided for detecting radiation emitted by the sample 250 due to electron beam excitation thereof. Furthermore, any other suitable detector may be employed.

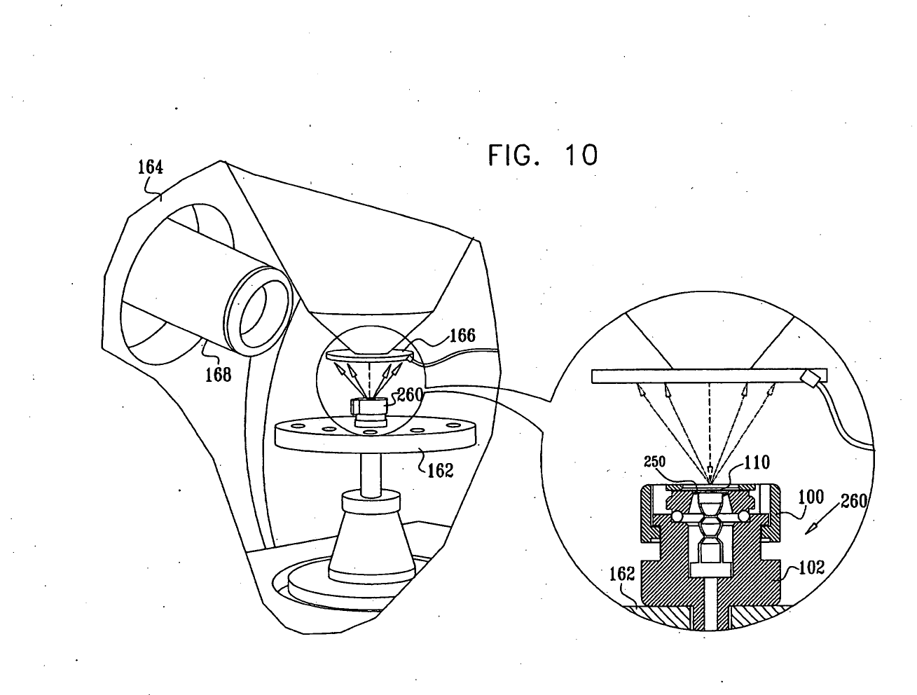

Reference is now made to FIGS. 11A-13, which are respective simplified top and bottom view pictorial illustrations, a sectional illustration and an exploded view illustration of a sample stage, such as a sample container support assembly, constructed and operative in accordance with yet another embodiment of the present invention. As seen in FIGS. 11A-13, a sample container support assembly 300 may include a main subassembly 302 mounted on a base 304 and may be attached thereto by screws 306 or by any other suitable manner. Main subassembly 302 may include a first portion 308 engaged with a second portion 310. A top plate 312 may be attached to main subassembly 302 by screws 314 or by any other suitable manner.

Alternatively, base 304, main subassembly 302 and top plate 312 may be integrally formed as one piece.

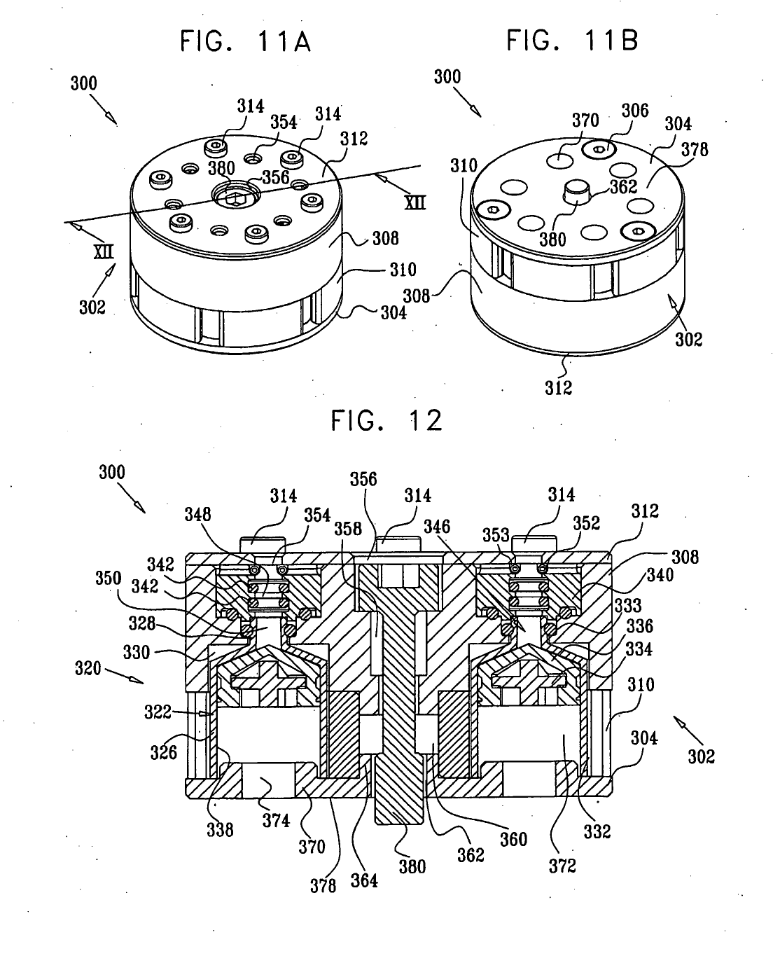

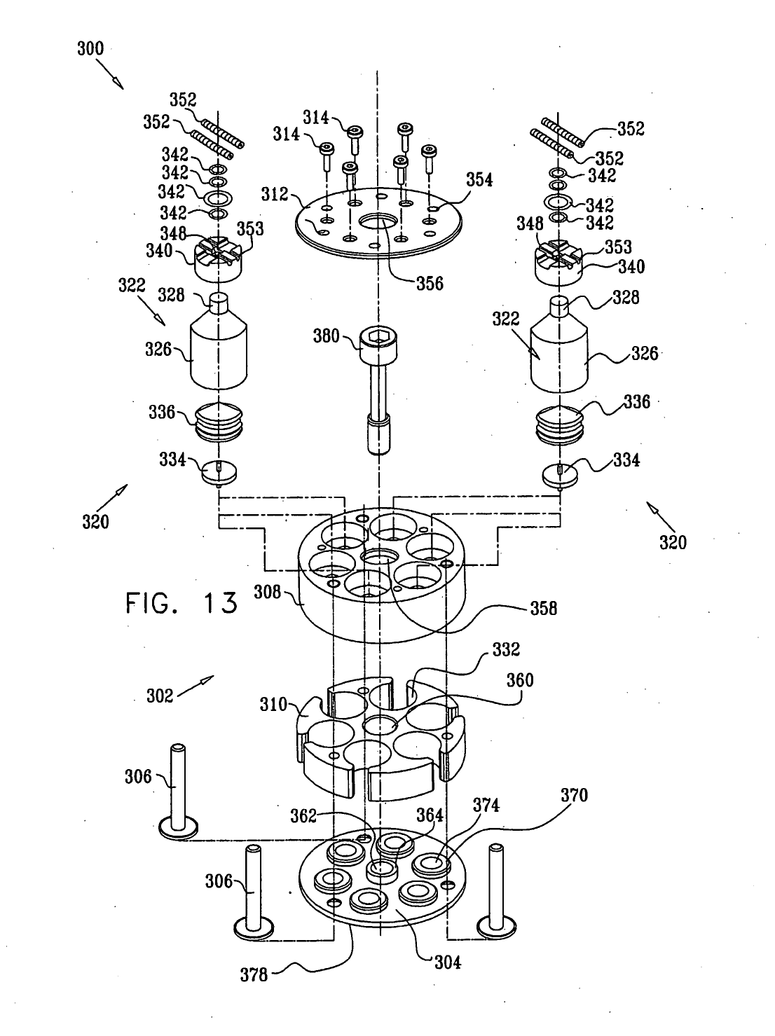

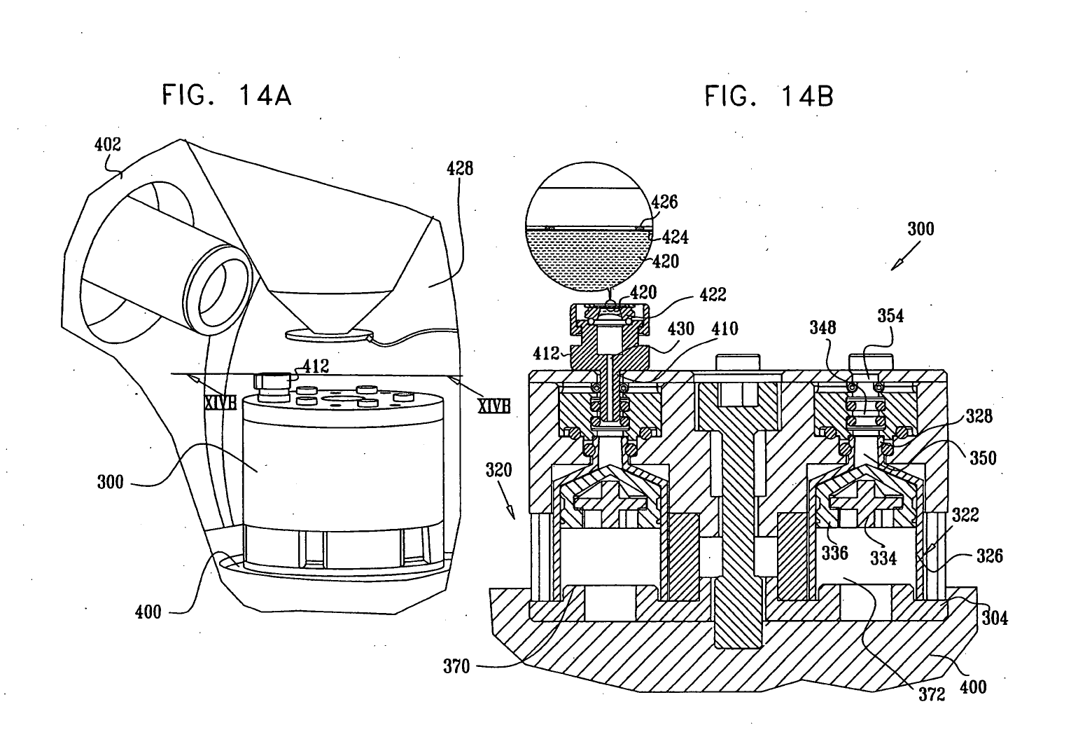

As seen in FIGS. 12 and 13, main subassembly 302 may include pressure controller functionality, such as a relief assembly or a piston actuated assembly or a pressure controller assembly 320 communicating between a sample enclosure and a volume outside a sample enclosure, as will be further described in reference to FIGS. 14A-16B. Relief assembly or piston actuated assembly or pressure controller assembly 320 may prevent longitudinal displacement of a membrane of a sample container (FIGS. 14A-16B) beyond a selected longitudinal distance, which may be an effective, operable or operative longitudinal distance wherein imaging of a sample in the sample container in a microscope may be impaired. Furthermore, the piston actuated assembly or the pressure controller assembly 320 may maintain a volume of the sample container at a pressure, whereby a pressure differential across the membrane does not exceed a threshold level at which excessive bowing out of the membrane may occur.

A housing 322 of pressure controller assembly 320 may include a generally cylindrical portion 326 which may taper and extend to a top portion 328. Cylindrical portion 326 may be sealingly mounted within a first recess 330 formed in first portion 308 of main subassembly 302 and a second recess 332 formed in second portion 310 of main subassembly 302. Top portion 328 may be sealingly mounted within a recess 333 formed in first portion 308. A displacing element assembly or a pressure controller subassembly or a relief subassembly, such as a piston assembly including a piston or other moveable device 334 may be, for example, seated within a grooved guiding element 336, which may be operative to slidably move along an internal wall 338 of cylindrical portion 326 of housing 322 in a longitudinal orientation. Other seating mechanisms may be used. Piston 334 of piston assembly may be provided to enlarge a volume surrounding a sample in a sample container (FIGS. 14A-16B), thereby reducing a pressure within the sample container.

It is appreciated that the pressure controller assembly 320 may include any suitable method for controlling the pressure within the sample container support subassembly 300 and a sample container (14A-16B).

An O-ring housing 340 may include a single O-ring or a plurality of O-rings 342 mounted therein for enhanced sealing of a fluid passageway 346 from a volume outside of said sample support assembly. Fluid passageway 346 may be defined within a central bore 348 formed in O-ring housing 340 and an internal volume 350 defined within top portion 328 of housing 322. It is appreciated that O-rings 342 may not be used and any other suitable sealant or sealing mechanism may be employed.

A pair of conductive springs 352 may be seated within mutually parallel grooves 353 defined within O-ring housing 340. Conductive springs 352 may be operative to prevent accumulation of electrical charge within a sample container due to excitation of an electron beam thereon, as will be further described in reference to FIGS. 14A-16B. Conductive springs 352 may be formed of a stainless steel material, it being appreciated that any suitable material may be used. Furthermore, a single spring or a plurality of springs may be used and any suitable conductive element may be used in place of springs 352.

Top plate 312 may be formed with a plurality of apertures 354, which may be peripherally positioned about a central aperture 356. Each aperture 354 may overlie central bore 348 of O-ring housing 340. Central aperture 356 may overlie a first thoroughgoing bore 358 formed in first portion 308, a second thoroughgoing bore 360 formed in second portion 310 and a recess 362 defined within a central protrusion 364 protruding from base 304.

Base 304 may define a plurality of peripheral protrusions 370 underling an internal volume 372 defined within housing 322 of pressure controller assembly 320. A recess 374 may be formed in each protrusion 370 and extend therethrough to a bottom surface 378 of base 304. A connecting element, such as a bolt 380, for example, may be mounted in first thoroughgoing bore 358, second thoroughgoing bore 360 and recess 362 and extends outwardly from bottom surface 378 of base 304. Alternatively, bolt 380 may be obviated and any suitable method for engaging sample container support assembly 300 with an inspection system (FIGS. 14A-16B) may be employed.

In one embodiment the sample container support assembly 300 is sized and operative with conventional stages of conventional microscopes (FIGS. 14A-16B). It is appreciated that various configurations and sizes of the sample container support assembly 300 may be provided so as to fit various microscopes.

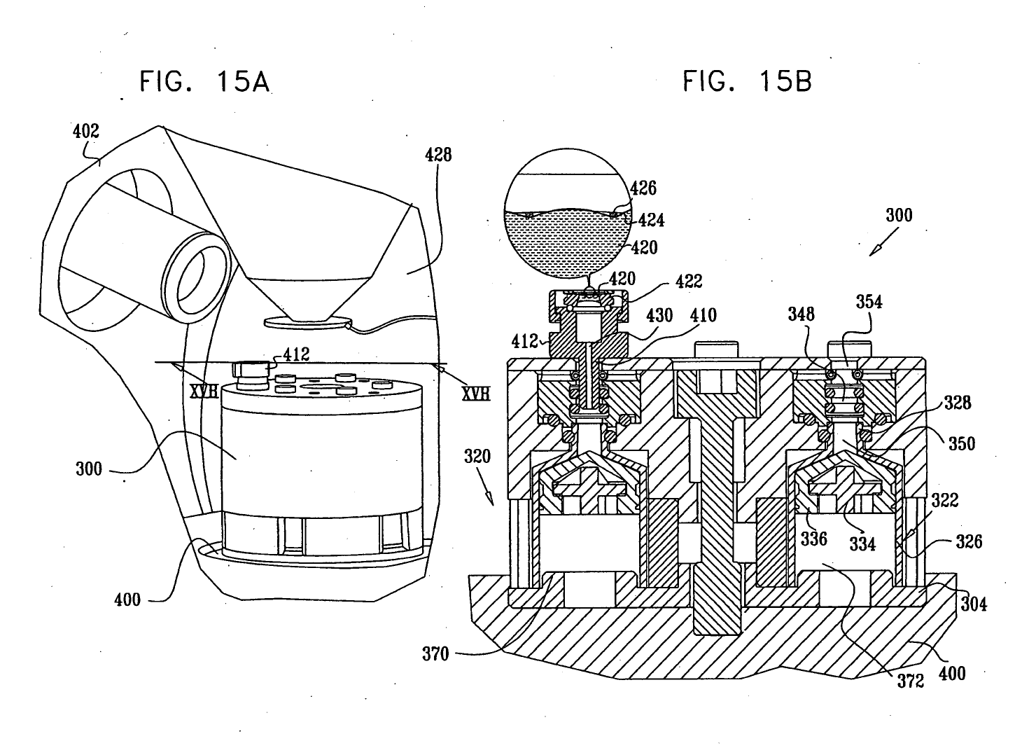

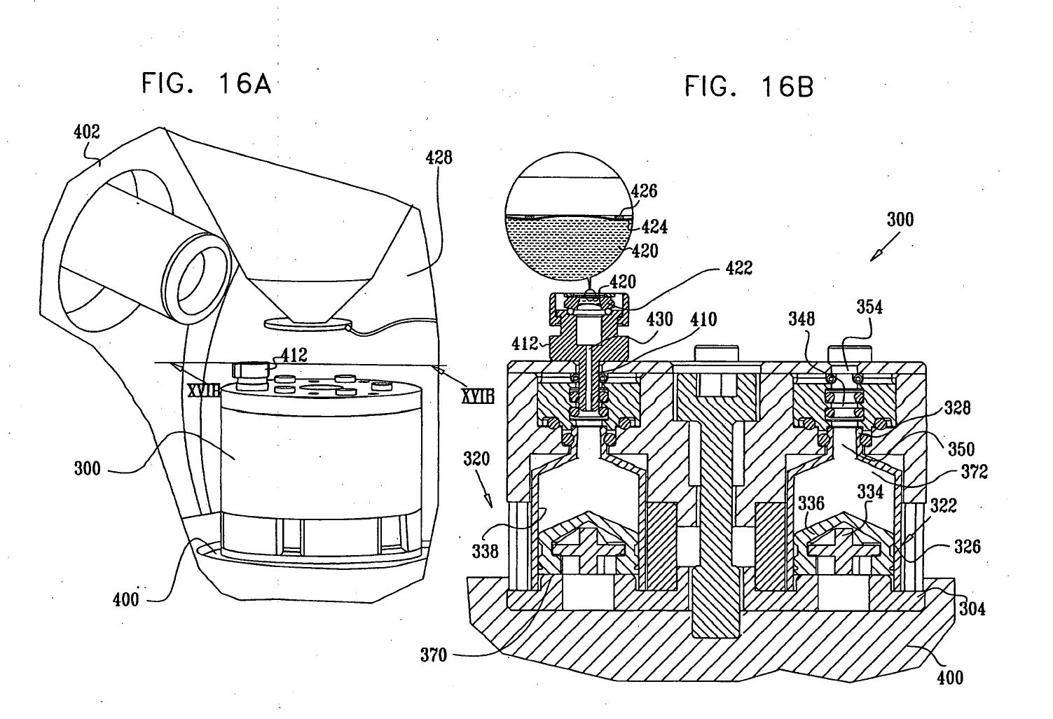

Reference is now made to FIGS. 14A-16B, which are, respectively, a simplified pictorial illustration and a simplified sectional illustration taken along lines XIVB-XIVB in FIG. 14A together showing the operative orientation of the sample container support assembly with a sample container at an initial stage of operation and a simplified pictorial illustration and a simplified sectional illustration taken along lines XVB-XVB in FIG. 15A together showing the operative orientation of the sample container support assembly with a sample container at an intermediate stage of operation and a simplified pictorial illustration and a simplified sectional illustration taken along lines XVIB-XVIB in FIG. 16A together showing the operative orientation of the sample container support assembly with a sample container at an advanced stage of operation.

As seen in FIGS. 14A and 14B, sample container support assembly 300 may be threadably mounted onto a floor 400 of an inspection system, typically a SEM 402, such as, for example, a Catalog No. XL130 commercially available from FEI UK Ltd. Of Philips House, Cambridge Business Park, Cowley Road, Cambridge, UK. Sample container support assembly 300 may be placed in the inspection system, such as a microscope, employing any suitable method.

A stub 410 of a sample container 412 is seated or mounted in aperture 354 and central bore 348 of sample container support assembly 300. Sample container 412 may be, for example, a sample container including elements of the sample container described hereinabove in reference to FIGS. 1A-10. Sample container 412 may be a sample container disclosed in embodiments described in PCT patent application WO/2004/075209, which is hereby incorporated by reference herein in its entirety; PCT patent application WO03/104848, which is hereby incorporated by reference herein in its entirety and PCT patent application WO03/104846, which is hereby incorporated by reference herein in its entirety. Other sample containers may be used with embodiments of the present invention. Sample container 412 may be operative to contain a sample, such as a fluid-containing sample 420, for example, and may be inspected in the SEM 402. Sample 420 may be placed in a sample enclosure 422 of sample container 412. Sample enclosure 422 may be substantially similar to ring 116 of FIGS. 1A-10. An electron beam (not shown), generated by the SEM 402, passes through a membrane, such as an electron beam permeable, fluid impermeable, membrane 424 of sample container 412 and impinges on sample 420. A grid 426 may mechanically support membrane 424. Membrane 424 may be substantially similar to membrane 110 of FIGS. 1A-10 and grid 426 may be substantially similar to grid 114 of FIGS. 1A-10.

As seen in FIG. 14B, the sample container support assembly 300 is shown prior to the evacuation of an internal SEM volume 428 defined by SEM 402. At this stage of operation a pressure of the internal SEM volume 428 may be substantially similar to a pressure of a volume outside the SEM 402 and a pressure of an internal volume 430 of sample container 412 may be substantially similar to the pressure of internal SEM volume 428. The effective sample container volume, which is a volume surrounding the sample 420, at this stage of operation, may include the internal volume 430 of sample container 412 and internal volume 350 of top portion 328 of housing 322.

It is seen that piston 334 and guiding element 336 of pressure controller assembly 320 may be seated within an upper portion of cylindrical portion 326 of housing 322. The membrane 424 and grid 426 are seen in FIG. 14B to be generally planar.

Turning to FIG. 15B, it is seen that the sample container support assembly 300 is shown immediately following the evacuation of the internal SEM volume 428, typically at a vacuum of 10⁻²-10⁻⁶ millibars, so as to allow generation of the electron beam (not shown) for the inspection of sample 420. At this stage of operation the pressure of the internal SEM volume 428 may be approximately a vacuum pressure and the pressure of the internal volume 430 of the sample container 412 may remain to be substantially similar to the pressure of the volume outside the SEM 402.

In FIG. 15B it is shown that membrane 424 and grid 426 may be displaced or bow outwardly due to pressure buildup in the internal volume 430 of the sample container 412.

As seen in FIG. 16B, the sample container support assembly 300 is shown some time following the evacuation of the internal SEM volume 428. At this stage of operation a pressure differential across the membrane 424, caused by a difference in the pressure within the internal volume 430 of sample container 412 and the internal SEM volume 428, may cause a pressure buildup within the internal volume 430 of sample container 412. The pressure buildup within the internal volume 430 may subsequently cause the piston 334 and guiding element 336 to glide downwardly along internal wall 338 of housing 322. The longitudinal motion of piston 334 and guiding element 336 may be stopped by, for example, protrusion 370 of base 304.

The displacement of piston 334 and guiding element 336 may enlarge the effective sample container volume, to include, at this stage of operation, the internal volume 430 of sample container 412, the internal volume 350 and a portion of internal volume 372 of housing 322. The effective sample container volume may be enlarged by, for example, a factor of 5, thus reducing the pressure differential across membrane 424. It is appreciated that the effective sample container volume may be enlarged to any suitable degree. Furthermore, the piston 334 my allow fluid to flow out of sample container 412 into internal volume 350 of the sample container support assembly 300, thus reducing the pressure differential across membrane 424.

It is seen in FIG. 16B that the membrane 424 may be displaced or bow outwardly to a significantly lesser extent than in FIG. 15B, due to the enlargement of the effective sample container volume.

It is noted that imaging of sample 420 in sample container 412 in SEM 402 is substantially similar to imaging of a sample described in reference to FIGS. 5 and 10 hereinabove.

It is noted that the sample 420 does not flow out of the sample container 412 due to surface tension of the membrane 424.

It is appreciated that various types of sample containers constructed and operative to contain various types of samples, such as solid-containing samples, may be inserted in the container support assembly 300. Such sample containers may be, for example, a sample container including elements of the sample container described hereinabove in reference to FIGS. 6A-10. Sample container 412 may be a sample container, for example, a sample container disclosed in embodiments described in PCT patent application WO/2004/075209, which is hereby incorporated by reference herein in its entirety; PCT patent application WO03/104848, which is hereby incorporated by reference herein in its entirety and PCT patent application WO03/104846, which is hereby incorporated by reference herein in its entirety. Other sample containers may be used with embodiments of the present invention.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1-31. (canceled)

32. A sample container assembly for use in a microscope comprising:
a sample enclosure;
an electron beam permeable, fluid impermeable, membrane sealing said sample enclosure from a volume outside said sample enclosure; and
a pressure controller assembly communicating between said sample enclosure and a volume outside said sample enclosure.

33. A sample container assembly for use in a microscope according to claim 32 and wherein said pressure controller assembly is to prevent longitudinal displacement of said membrane beyond a selected longitudinal distance.

34. A sample container assembly for use in a microscope according to claim 32 and wherein said pressure controller assembly is to maintain a volume of said sample enclosure at a pressure, whereby a pressure differential across said membrane does not exceed a threshold level at which excessive bowing out of said membrane would occur.

35. A sample container assembly for use in a microscope according to claim 32 and wherein said pressure controller assembly comprises a flexible tube element.

36. A sample container assembly for use in a microscope according to claim 35 and wherein said pressure controller assembly comprises a fluid passageway communicating with said flexible tube element.

37. A sample container assembly for use in a microscope according to claim 32 and wherein said pressure controller assembly comprises a piston assembly.

38. A sample container assembly for use in a microscope according to claim 32 comprising a sample support assembly.

39. A sample inspection system comprising:
a sample container assembly for use in a microscope according to claim 32; and
a microscope.

40. A sample inspection system according to claim 39 comprising at least one of:
an X-ray detector arranged to receive X-rays from a sample in said sample enclosure;
a light detector arranged to receive light in the ultraviolet to infrared range from a sample in said sample enclosure;
a backscattered electron detector arranged to receive backscattered electrons from a sample in said sample enclosure; and
a secondary electron detector arranged to receive secondary electrons from a sample in said sample enclosure.

41. A sample container assembly for use in a microscope according to claim 32 comprising a positioner, including an accordion type element for positioning a sample generally in proximity to said membrane.

42. A sample container support assembly comprising:
a pressure controller assembly comprising a piston assembly;
an aperture for placing a sample container in said sample container support assembly; and
a fluid passageway connecting said aperture with said pressure controller assembly.

43. A sample container support assembly according to claim 42 and wherein said piston assembly is to enlarge a volume surrounding a sample in said sample container, thereby reducing a pressure within said sample container.

44. A sample container support assembly according to claim 42 and wherein said sample container comprises:
a sample enclosure; and
an electron beam permeable, fluid impermeable, membrane sealing said sample enclosure from a volume outside said sample enclosure.

45. A method of microscopy comprising:
allowing fluid to flow out of a sample enclosure of a sample container with a sample therein,
said sample container placed in an evacuated environment of a microscope, said sample enclosure sealed by an electron beam permeable, fluid impermeable, membrane; and
imaging results of interactions of a beam of electrons with said sample in said sample container.

46. A method of microscopy according to claim 45 and wherein said allowing is for preventing longitudinal displacement of said membrane beyond a selected longitudinal distance.

47. A method of microscopy according to claim 45 and wherein said allowing is for maintaining a volume of said sample enclosure at a pressure, whereby a pressure differential across said membrane does not exceed a threshold level at which excessive bowing out of said membrane would occur.

48. A method of microscopy according to claim 45 and wherein said allowing comprises releasing fluid from said sample enclosure via a flexible tube element.

49. A method of microscopy according to claim 48 and wherein said releasing comprises flowing of said fluid from said sample enclosure through a fluid passageway to said flexible tube element.

50. A method of microscopy according to claim 45 and wherein said allowing comprises moving a piston assembly.

51. A method of microscopy according to claim 50 and wherein longitudinal movement of a piston of said piston assembly enlarges a volume surrounding said sample in said sample container, thereby reducing a pressure within said sample container.
